(19) United States
(12) Patent Application Publication
(10) Pub. No.: US 2007/0227819 A1
(43) Pub. Date: Oct. 4, 2007

(54) WINDOW CLEANING LADDER

(76) Inventor: L. Diane Layfield, Locust Grove, GA (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/277,757

(22) Filed: Mar. 28, 2006

(51) Int. Cl. E06C 1/00

(52) U.S. Cl. 182/206; 182/163

(57) ABSTRACT

A ladder with first (10), second (11), third (12) and fourth (13) linear sections, the first and second sections being joined by a first joint section (20), the second and fourth sections being joined by a second joint section (21), and the third and fourth sections being joined by a third joint section (22). At least the first and third joint sections are preferably lockable and/or have a limited range of motion. When used with a window, the first section rests against the interior of the structure and prevents the ladder from being pulled out of the window. The second section lies on the windowsill and provides support for the ladder. The third section rests against the exterior of the structure to provide an angle for the ladder. The fourth section provides the rungs on which the worker stands to clean the windows.

### BACKGROUND OF THE INVENTION

1. Field of the Invention

The present invention relates to foldable and configurable ladders and, more particularly, to a ladder particularly adapted for cleaning windows from the exterior of a structure.

2. Description of the Related Art

Present methods for cleaning the exterior of a structure, such as cleaning the outside of a window on a structure, are varied and many can be troublesome. One method of cleaning the outside of window involves placing a ladder against the exterior of the building for the worker to climb on to reach the desired location. However, if the desired location is too high, such a ladder may not be feasible. Even if the desired location is not too high, it may be difficult to maneuver the ladder into position. Additionally, it may be difficult or impossible to find secure footing for the ladder to prevent the feet of the ladder from slipping or sinking when the worker starts climbing, or is on, the ladder. Further, even if the above problems can be overcome, the angle of lean or tilt of the ladder must be within certain bounds. If the angle is too steep, the ladder and the worker may be prone to fall backward off the ladder. If the angle is too shallow, the feet of the ladder may slip out or the ladder may not allow the worker to reach the desired location.

Moving a 28- or 40-foot extension or fixed (non-extendible) ladder into position, getting it into an approximately upright position, extending it if necessary, making sure that it is properly braced and not on soft or unstable ground, climbing that wobbly ladder, and then trying to clean a window with one hand while holding on to the ladder with the other hand, can be a harrowing experience and may not be for the faint-hearted or the weak, as will quickly be appreciated by anyone who has tried it. Further, a long ladder may flex and/or wobble excessively.

Another method of cleaning the outside of a window on a structure involves places the cleaning equipment on a long pole held, positioned, and manipulated by the worker. However, there are limits to how high the pole can reach, those limits being set by the worker's strength, the worker's ability to control the position of the cleaning equipment, and the tendency of the pole to flex or bend. Still another method of cleaning the outside of a window on a structure involves erecting scaffolding proximal to the structure. There are still height limits with scaffolding, the cost is substantially higher, the scaffolding must be placed on secure ground, and the scaffolding may not easily fit or be assembled within the space available. There also is the age-old method of simply leaning out the window and holding onto something or someone with one hand while cleaning the window with the other hand. Although requiring no additional equipment, the dangers of this method are clearly apparent, especially to one who has used that method.

Various ladder type devices for use in connection with a window of a structure are known. U.S. Pat. No. 6,578,664 to Doherty discloses a window guard that can double as a ladder, is attached to the outside of the building and is not portable. U.S. Pat. No. 5,871,067 to Parenti discloses a permanently affixed folding emergency escape ladder that is attached to the outside of the building and is not portable. U.S. Pat. No. 5,845,741 to Dwyer discloses an escape apparatus having an interior section, a window sill section, a ladder section, and a spacer section, which is not portable and is not meant to hang from the windowsill, but to be attached to the wall.

U.S. Pat. No. 5,022,491 to Gill discloses a collapsible fire escape ladder that attaches to the outside of a building near a window, has an interior section, a windowsill section, a ladder section, and spacers, is not portable, and is not meant to hang from the windowsill, but to be attached to the wall. U.S. Pat. No. 4,815,561 to Ostrander discloses an escape device that is attached at or near a windowsill and includes a foldable ladder section and spacers. U.S. Pat. No. 4,751,982 to Wolfe discloses a foldable ladder that has hook devices to hang from a windowsill and in which the stairs fold flat to each other.

U.S. Pat. No. 3,946,833 to Riehlmann discloses a collapsible ladder suitable for use as a fire escape that attaches to the outside of a window and comprises a two-section ladder that collapses in on itself. U.S. Pat. No. 3,847,246 to Banner discloses an emergency fire exit means that attaches to the outside of a window and comprises a fold-out platform and a folded ladder that, when activated, the platform swings to horizontal and the ladder is released to unfold and allow escape. U.S. Pat. No. 2,946,398 to McNulty discloses a collapsible metal ladder stored within a box inside of a building below a window and is made from sections of rod.

U.S. Pat. No. 1,032,810 to Bosnyakovits discloses a fire escape comprising an interior section, a windowsill section and a ladder section and is a device that is mounted inside the building and is flipped outside the building for escape. U.S. Pat. No. 261,847 to Graff discloses a fire escape comprising a foldable metal ladder stored within a box inside of a building below a window and is unfolded and dropped outside the window against the building. This device has spacers to allow stepping space between the building and the ladder.

As can be seen, there is a need for a safe and convenient way of addressing cleaning the exterior of a window or otherwise accessing the exterior of a building. Additionally, there is a need for a portable and easily stored device for cleaning the exterior of a window and otherwise accessing the exterior of a building. Further, there is a need for a relatively simple, generally easy to use, and relatively economical to manufacture device for cleaning the exterior of a window and otherwise accessing the exterior of a building. It is to these needs among others that the present invention is directed.

### BRIEF SUMMARY OF THE INVENTION

The present invention provides a ladder which overcomes the deficiencies of the prior art. Briefly, the ladder has four sections connected by preferably at least partially pivotable joints. When used with a window, a first section is located inside the building structure, such as a house, in a position proximal to the window and abutting against the interior of the structure typically below the window so as to prevent the ladder from falling out of the window. A second section lies on the windowsill and provides support for the ladder and a connection between the first section and a third section. The third section is located outside of the building structure and is braced against the exterior of the structure to provide an angle for the ladder. A fourth section also is located outside of the building also in a position proximal to the window, is connected between the second and third sections, and provides the rungs on which the worker stands to clean the windows.

Somewhat more particularly described, the ladder has a first, second, third and fourth linear sections, the first and second sections being joined by a first joint section, the second and fourth sections being joined by a second joint section, and the third and fourth sections being joined by a third joint section. At least the first and third joint sections preferably are lockable or have a limited range of motion, or both, relative to each other. The linear sections preferably have first and second sides or rails and at least the fourth section has a plurality of rungs. Extending braces may be added to the first section to further prevent the ladder from falling out of the window. Extending braces also may be added to the third section to bridge a gap or a lower window.

In somewhat more detail, the invention is a ladder device that the user can hang from a windowsill, climb out on, and wash the window. A first section of the ladder remains inside the building (house) and braces against the interior wall below the window to be washed (or repaired). A second section of the ladder lies horizontal across the windowsill. A third section of the ladder separates the ladder from the building siding so that a fourth of the ladder remains at a comfortable angle away from the building. The fourth section of the ladder comprises generally horizontal rungs or steps and is for the user to stand on when washing (or repairing) the window.

The invention preferably is foldable for shipping and storage, and for ease of extending out of the window. Thus, the joint sections between the linear sections preferably are foldable joints allowing folding of the invention for transport and storage and for adjustment of the invention before and when in use. The third section preferably is slidable up and down at least a portion of the fourth section such that the third section can be moved to avoid leaning against a lower window or a gap in the building exterior. The third section also can have an optional extended ends to brace against the building to prevent the ladder from flopping around.

The first and second sections can have padding to contact the interior wall and the windowsill to prevent damage. The fourth section can have a hinge in the middle so that it can be folded so as to make the folded ladder even smaller for storage and shipping. Braces can be attached to the hinged joints between the first and second sections and the second and fourth sections to prevent the ladder from “opening up” and falling out the window. These braces keep the angle between the first and second sections and between the second and fourth sections from opening up to more than about 100 degrees. Alternatively, the joint sections can have locking joints or hinges to accomplish this goal. An optional upwardly extending retractable extension can be attached to the top or side of the fourth section. This extension can be raised to provide a handhold when the user is standing on the top few steps of the invention and lowered for storage. The ladder preferably is made of aluminum or some other lightweight metal material, composites such as glass composites and carbon composites, or any other material of suitable strength and weight.

These features, and other features and advantages of the present invention, will become more apparent to those of ordinary skill in the relevant art when the following detailed description of the preferred embodiments is read in conjunction with the appended drawings in which like reference numerals represent like components throughout the several views.

### BRIEF DESCRIPTION OF THE DRAWINGS

FIG. 1 is side plan view of an exemplary embodiment of the ladder of the present invention in an exemplary environment.

FIG. 2 is a more detailed side plan view of the exemplary embodiment of the ladder shown in FIG. 1 in an exemplary environment.

FIG. 3A is a plan view of a locking joint for use in a locking joint section of the present invention.

FIG. 3B is a side plan view of the ladder of the present invention showing the preferred placement of the locking joints shown in FIG. 3A.

FIG. 4 is a front view of one section of the ladder.

FIG. 5 is a side view of the ladder in the folded position for transport and/or storage.

FIG. 6 is a front view of an optional extension brace.

### DETAILED DESCRIPTION OF THE PREFERRED EMBODIMENTS

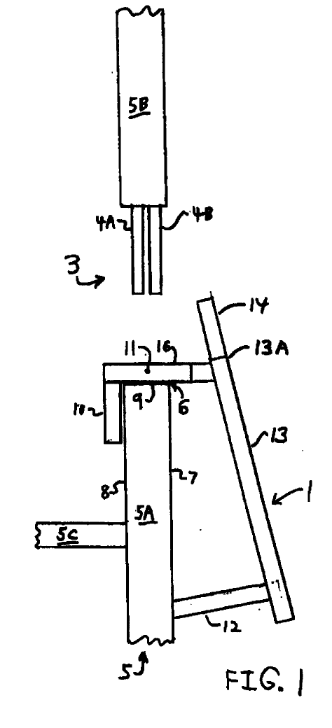

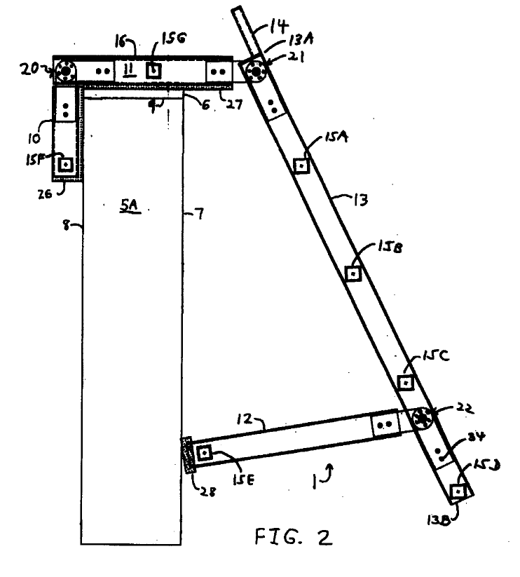

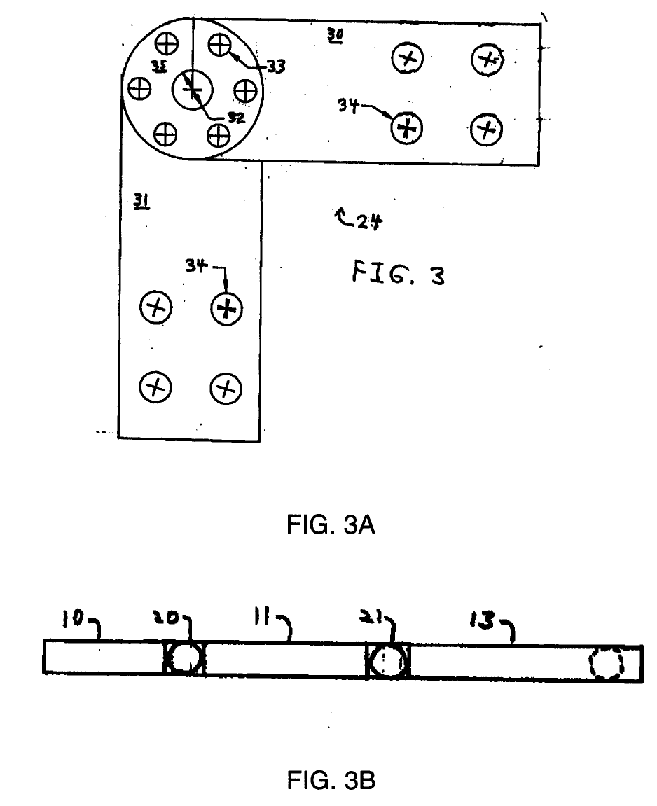

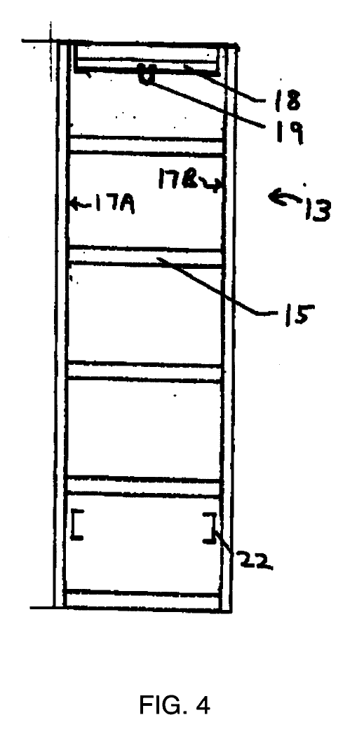

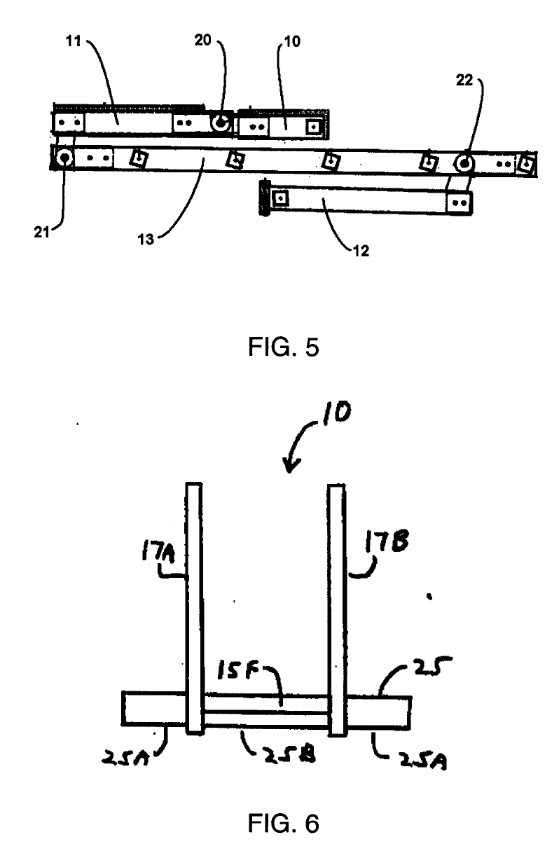

FIG. 1 is a side plan view of an exemplary embodiment of the ladder 1 of the present invention shown in a preferred position in a window opening 3 of a structure 5. FIG. 2 is a more detailed illustration of the exemplary embodiment of the ladder 1 in an exemplary environment. FIG. 3A is a side view a locking joint 24 for use in a locking joint section. FIG. 3B is a side plan view of the ladder 1 of the present invention showing the preferred placement of the locking joints 24 shown in FIG. 3A along the ladder 1. FIG. 4 is a front view of the fourth linear section 13 of the ladder 1 showing a preferred construction. FIG. 5 is a side view of the ladder 1 in the folded position for transport and/or storage. FIG. 6 shows an optional extension brace 25 for use in stabilizing the ladder 1.

Referring now to FIG. 1, an illustration of an exemplary embodiment of the ladder 1 of the present invention is shown in an exemplary environment. A building structure 5, such as a house with window openings 3, has a window opening 3 that has movable window sections 4A, 4B, both shown in the raised position, a lower wall section 5A located below the window opening 3, an upper wall section 5B located above the window opening 3, and a floor 5C. The lower wall section 5A has an exterior surface 7, such as for illustrative purposes brick, stucco, wood or other building materials, and an interior surface 8, such as for illustrative purposes wallboard, paneling, tile, or other building materials. The upper wall section 5B also has an exterior surface and an interior surface, which are shown but not separately numbered. The lower wall section 5A also has a top surface or ledge 9 forming the bottom of window opening 3, which is typically covered, such as by a windowsill 6. The ladder 1 is shown in use with the lower wall section 5A.

The ladder 1 has a first linear section 10 for bracing against the interior of the structure 5, a second linear section 11 for bracing on and being supported by the window sill 9, a third linear section 12 for bracing against the exterior of the structure 5 and for angling the ladder 1, and a fourth linear section 13 upon which a worker can stand for purposes of cleaning or repairing the window 4 or the exterior surface 7 of the structure 5. The fourth linear section 13 has rungs or other footholds (15, but not shown in FIG. 1) upon which the worker can stand. There also can be an optional extension section 14 at the upper end 13A of fourth linear section 13. This extension section 14 preferably provides additional sides or rails for the workman to hold for safety and/or comfort. This extension section 14 preferably is secured to the insides of the rails of the fourth linear section 13 by any convenient means, such as, but not limited to, screws, bolts and nuts, welding, etcetera. This extension section 14 alternatively could be secured to the outsides of the rails of the fourth linear section 13 if desired, or constructed as a telescoping feature. Positioning and/or design of the extension section 14, if used, is selected so as not to interfere with the operation of the second joint section 21.

By way of example, and not of limitation, in a preferred embodiment the first linear section 10 has a length of between 4 inches and 30 inches, which should be sufficient to provide satisfactory support for the ladder 1 against the interior surface 8 when the ladder 1 is mounted in the window opening 3. One embodiment satisfactory for use in a house setting has a first linear section 10 having a length of approximately 8⅞ inches. Also by way of example, and not of limitation, in a preferred embodiment the second linear section 11 has a length of between 6 inches and 30 inches, which should be sufficient to provide satisfactory support for the ladder 1 on the window sill 9 when the ladder 1 is mounted in the window opening 3. In the embodiment satisfactory for use in a house setting, the second linear section 11 has a length of approximately 18⅜ inches. Also by way of example, and not of limitation, in a preferred embodiment the third linear section 12 has a length of between 6 inches and 30 inches, which should be sufficient to provide satisfactory support for the ladder 1 against exterior surface 7 and to provide a comfortable working angle when the ladder 1 is mounted in the window opening 3. In the embodiment satisfactory for use in a house setting, the third linear section 11 has a length of approximately 21¼ inches. Also by way of example, and not of limitation, in a preferred embodiment the fourth linear section 13 has a length of between 36 inches and 60 inches, which should be sufficient to provide a satisfactory working length for the worker when the ladder 1 is mounted in the window opening 3. In the embodiment satisfactory for use in a house setting, the fourth linear section 11 has a length of approximately 50 inches. The extension section 14, if used, has a length of between 3 inches and 12 inches, not including any overlap used to secure it to the fourth section 13. The dimensions for linear sections 10, 11, 12, 13 and extension 14 are not critical, and larger or smaller dimensions may be used to accommodate particular requirements and/or environments. For example, the length of second linear section 11 may be different if the width of the wall 5A is significantly thicker or thinner.

The linear sections 10, 11, 12, 13 preferably are constructed from two parallel ⅛ by 2½ inch formed I-channel rails. The structural rails preferably are positioned approximately 6 inches to 30 inches apart, and more preferably approximately 14-18 inches apart from outer edge to outer edge of the rails. The extension section 14 is preferably ⅛ inch to ¼ inch thick by ¾ inch to 2 inch square formed channel, but may be rectangular channel if desired, ad preferably is ⅛ inch by 1 inch formed channel. The dimensions for linear sections 10, 11, 12, 13 and extension section 14 are not critical, and larger or smaller dimensions may be used to accommodate particular requirements and/or environments. For example, the distance between parallel beams may be different if the width of the window opening 3 is significantly more or less. The ladder preferably also has an optional top plate 16 secured to and covering most, if not all, of the top side of second section 11 by any desired means, for example, screws, bolts and nuts, rivets, welding, etcetera.

Referring now to FIG. 2, a more detailed illustration of the exemplary embodiment of the ladder 1 in an exemplary environment is shown, and shows the top 9 and the windowsill 6 of the wall section 5A. In addition, FIG. 2 also shows the various joint sections, 20, 21, 22 connecting the linear sections 10, 11, 12, 13 to each other. Reference also is made to FIG. 3A and FIG. 3B for the following discussion of joint sections 20, 21, 22.

Preferably, at least first joint section 20 has a locking joint or other locking means that can be moved into a desired position and then locked in that position, thus locking first linear section 10 in position relative to second linear section 11. A joint section, such as first joint section 20, preferably comprises two joints, one joint for each side or rail of the ladder 1. The two joints of a joint section 20, 21, 22 may be different (lockable, having a limited range of motion, or being unrestricted) but, for stability and safety, are preferably the same and are locking joints. In an alternative embodiment, first joint section 20 has a limited range of motion so that first linear section 10 can be folded toward or into second linear section 11, but cannot have an angle larger than approximately 90 degrees with respect to first linear section 10. In another alternative embodiment, first joint section 20 has an initial limited range of motion of approximately zero to 90 degrees but can be unlocked to permit a greater range of motion, for example, 180 degrees, so that first linear section 10 can be made to extend in line with second linear section 11.

Similarly, the second joint section 21 may be lockable, may have a limited range of motion, or may be unrestricted. Preferably, second joint section 21 is also lockable and can be adjusted to provide the correct angle for deployment and use of the ladder. Likewise, the third joint section 22 may be lockable or may have a limited range of motion but is preferably lockable. In an alternative embodiment, third joint section 22 has a limited range of motion so that third linear section 12 can be folded toward or into fourth linear section 13, but cannot have an angle larger than approximately 90 degrees with respect to fourth linear section 13. In another alternative embodiment, third joint section 22 has an initial limited range of motion of approximately zero to 90 degrees but can be unlocked to permit a greater range of motion, for example, 180 degrees, and is positioned on fourth linear section 13 so that third linear section 12 can be made to extend in line with fourth linear section 13.

In order to prevent scuffing, marring, or other damage to the wall structure 5A, the ladder 1 preferably, but only optionally, has several protective coverings 26, 27, 28. The protective coverings 26, 27, 28 may be secured to their respective linear sections 10, 11, 12, or to other appropriate locations, by any desired means, such as an adhesive, bolts, clips, hook-and-loop fastener, etcetera. The protective covering 26, 27, 28 may be any convenient and desired material which will protect the interior 8 of the wall 5A from damage by the ladder 1. The protective covering 26, 27, 28 may be, for example, heavy foam rubber, a fabric pad, etcetera. First protective covering 26 is on the part of first linear section 10 which rests against the interior 8. This first protective covering 26 also may extend around and cover the end of the first linear section 10 if desired. Second protective covering 27 is on the underside of second linear section 11, and protects the windowsill 6 or ledge 9 if the windowsill 6 is absent. Third protective covering 28 is on the end or foot of third linear section 12, and protects the exterior 7 of the wall 5A. Protective coverings may also be provided in other places, not shown, in order to further protect the wall 5A during deployment and retraction of the ladder 1. For example, protective coverings may be placed on the surface of fourth linear section 13 facing the wall 5A, on the bottom side of third linear section 12, etcetera.

The ladder 1 has a plurality of rungs 15 upon which the worker may stand. Reference also is made to FIG. 4 for the following discussion of rungs 15. For convenience of illustration, only four rungs 15A, 15B, 15C, 15D are shown in FIG. 2, and five in FIG. 4, for use by the worker to stand on when ladder 1 is in the operating position. However, the number of rungs 15 used would depend upon the desired spacing between the rungs 15, such as 10 inches or 12 inches, and the length of fourth linear section 13, which is approximately 50 inches in the preferred embodiment, but may be somewhat shorter or longer depending upon the environment in which the ladder 1 will be used. Optional rung 15F on first linear section 10 is a structural rung for maintaining the structural integrity and dimensional stability of first linear section 10, but may be used by the worker as an aide to climb onto the top surface 16. Optional rung 15E on third linear section 12 and optional rung 15G on second linear section 11 also are structural rings for maintaining the structural integrity and dimensional stability of third linear section 12 and second linear section 11, respectively and would typically not be used by the worker. That is, to prevent the sides of the linear sections 11, 12 from excessively deforming inwardly or outwardly.

The rungs 15 are preferably shaped rungs. One example is the preferred square shape shown, which is made from, for example, ⅛ inch by 1½ inch square aluminum tubing or stock. Other shapes, such as triangular, rectangular (flat), circular, are also possible. The rungs 15 are preferably welded to the I-channel rails but other means of securing the rungs 15, such as a threaded rod, nuts, and stabilizers to prevent rotation of a rung 15, may be used.

Referring now to FIG. 3A, a locking joint 24 for use in a locking joint section, such as first joint section 20, is shown in more detail. The locking joint 24 has first joint leg 30 and second joint leg 31. Each joint leg 30, 31 has a head 35 and a plurality of attachment holes 34. Each head 35 has a pivot hole 32 and a plurality of locking holes 33. The head 35 of leg 30 is shown, the head 35 of leg 31 being hidden underneath head 35 of leg 30.

The joint legs 30, 31 are fastened to the sides of their corresponding linear sections 10, 11, 12, 13, such as first linear section 10 and second linear section 11 for first joint section 20 of FIG. 2. The fastener (not shown) is inserted through the attachment holes 34 of the joint legs 30, 31 into corresponding holes present in the corresponding linear sections 10, 11, and then secured. The fastener may be, for example a bolt, a rivet, a rod, etcetera. If the fastener is a bolt then it may be secured by, for example, a locking washer and nut, a locking nut, etcetera. There may be four attachment holes 34 for each joint leg 30, 31, as shown in FIG. 3A, or only two attachment holes 34, as shown in FIG. 2. Alternatively, the joint legs 30, 31 could be welded to the linear sections 10, 11, 12, 13.

The pivot hole 32 extends through, and is aligned in, both joint legs 30, 31. A pivot piece (not shown) holds the two joint legs 30, 31 together. The pivot piece may be, for example, a bolt and a locking washer and nut, a bolt and a locking nut, a rivet, etcetera. Alternatively, the pivot piece may be a rod which goes through both joint legs 30, 31 of a locking joint 24, and which is secured to prevent withdrawal from the locking joint 24. This may be accomplished by, for example, flaring the ends of the rod, threading the ends of the rod and placing locking nuts thereon, bending the end of the rod at 90 degrees, etcetera.

The locking holes 33 are used to lock the joint legs 30, 31, and therefore their corresponding linear sections 10, 11, 12, 13, such as first linear section 10 and second linear section 11 for first joint section 20, into a fixed alignment with respect to each other. When the locking holes of joint leg 30 are aligned with the locking holes of joint leg 31 the worker can then insert a locking pin (not shown) through any two aligned locking holes 33. The locking pin may be as simple as a bolt which is pushed in, a large nail, a bolt and a nut, a large cotter pin, etcetera. The primary concern with the locking pin is that it be strong enough to withstand the sheer forces present between the joint legs 30, 31, that it prevent excessive movement of the locking joints 24, that it be easily inserted and removed, and that it not easily fall out.

Alternatively, locking joint 24 can be any conventional locking joint. For example, various locking joints currently are used on regular ladders and include locking holes that cooperate with spring actuated locking pins. The locking pin is depressed, thus allowing the joint legs to rotate relative to each other. Once the joint legs are in a desired position relative to each other such that a pair of locking holes lines up with each other, the spring will force the locking pin into the hole, thus locking the joint legs in a position. Other locking means are contemplated and are known in the art. For example, various ratcheting locking means are known and can be useful in this invention.

By way of example, and not of limitation, in the preferred embodiment the pivot hole 32 has a diameter of between ⅜ inch and 1 inch, and more preferably 9/16 inch, the attachment holes 34 have a diameter of between ⅜ inch and 1 inch, and more preferably 7/16 inch, and the locking holes 33 have a diameter of between ¼ inch and ¾ inch, and more preferably 5/16 inch. Also by way of example, and not of limitation, in the preferred embodiment the joint legs 30, 31 have a length of between 2 inches and 12 inches, and more preferably 6 inches and a width of between 1 inch and 4 inches, and more preferably 2 inches. These dimensions are not critical.

It will be noticed that heads 35 of joint sections 20, 21, 22 are shown as being within the linear sections 11, 12, 13. Accordingly, in the locking hole embodiment, the joint sections 20, 21 and 22 must also have the locking holes 33 so that the fastener can be inserted. Additionally, It is not a requirement, however, that the heads 35 be hidden. The joint legs 30, 31 may be dimensioned and/or positioned so that the heads 35 are exposed so that the joint sections 20, 21, 22 do not need the locking holes 33. Of course, this choice can be made on a joint section-by joint section basis, so that some heads 35 are hidden and some heads 35 are exposed.

FIG. 3B shows a side view of the ladder 1 with the first linear section 10, the second linear section 11 and the third linear section 12 in a straight configuration. This figure is to illustrate the positioning of first joint section 20 between first linear section 10 and the second linear section 11, and second joint section 21 between the second linear section 11 and the fourth linear section. Although the preferred joints have been shown, locking and/or limited range of motion joints of other designs may also be used.

Referring now to FIG. 4, a front view of the fourth linear section 13 of the ladder 1 is shown. Shown are the rungs 15 and the sides or rails 17A, 17B of this fourth linear section 13, an end view of the channels of joint section 22, a safety harness bar 18, and a safety harness U-bolt, latch, or hook 19. The other linear sections 10, 11, 12 have similar sides or rails. Not shown is the extension section 14. The bottom rung 15 may be at the bottom of the fourth section 13 as shown, or may be slightly above the bottom of the fourth section 13 for additional strength. As can be seen, the fourth linear section 13 is similar to a conventional ladder and, in effect, the fourth linear section 13 is used as a conventional ladder-type of device. The fourth linear section 13 has a plurality of rungs 15 both for structural rigidity and to allow the user to position herself on the ladder 1 for maximum usage. For example, after the user climbs out of the window opening 3 onto the fourth linear section 13, the user can stand on any of the rungs 15 so as to position herself at the correct or desired height for cleaning the window 4 or otherwise working on the window 4 or structure 5.

The safety harness bar 18 is preferably welded to either a rung 15 or to the sides 17. The safety harness equipment 18, 19 may be toward the top of the fourth linear section 13 section, as shown, may be slightly lower, may be one of several, or may be on an end of the second linear section 11. The safety harness equipment 18, 19 allows the worker to wear safety equipment, for example, a vest style harness and a shock absorbing lanyard. The safety harness equipment 18, 19, or additional safety harness equipment, also may be provided on the other sections so that, for example, when starting the worker may hook a first lanyard to a hook 19 on second linear section 11, back out of the window opening 3 onto the fourth linear section 13, and then hook a second lanyard to a hook 19 on fourth linear section 13, at which point the worker may disconnect the first lanyard from the hook on second linear section 11 and either stow it or connect it to the hook 19 on fourth linear section 13 for additional safety.

Referring now to FIG. 5, an illustration of the ladder 1 in the folded position for transport and/or storage. The various linear sections 10, 11, 12, 13, and the joint sections 20, 21, 22 are shown folded against each other. Not shown is the extension section 14, which will be partially within the rails of second linear section 11 and fourth linear section 13. If desired, third joint section 22 could be placed at the end of fourth linear section 13, so that the pivot piece for third joint section 22 also serves to secure the bottom rung to the fourth linear section 13. This would allow third linear section 12 to be extended to be in line with fourth linear section 13, which, along with extending all of the linear sections 10, 11, 12, 13 relative to each other, could allow the invention to function as a conventional ladder. Preferably, all of the linear sections 10, 11, 12, 13 are structured to fold into or parallel to each other to make a flatter folded ladder 1 for transportation and storage. In an alternative embodiment, the fourth linear section 13 is divided into two parts, 13A, 13B (not shown), connected by a lockable joint section (not shown). This allows the ladder to be folded even smaller for convenient transportation and/or storage.

Referring now to FIG. 6, an optional extension brace 25 on, for example, first linear section 10 is shown. The optional extension brace 25 may be desirable on first linear section 10 when, for example, extra assurance is desired that the entire ladder 1 cannot be inadvertently pulled through the window opening 3, especially when a worker is on the ladder 1. For clarity, the top plate 6 is not shown in FIG. 6. Preferably, the top of the extension brace 25 is not higher than the top of the rung 15F, if used, so as not to interfere with the use of the rung 15F. The optional extension brace 25 also may be desirable on third linear section 12 for use as a bridge if, for example, there is another window under the window opening 3 and there is no appropriate surface for the feet of the third linear section 12 to rest against. Similarly, the extension brace 25 can be used on fourth linear section 12 to provide extra stability for the ladder 1 when in use. The extension brace 25 may be secured to the appropriate section 10, 11, 12, 13 by any desired and convenient means. Preferably, the extension brace 25 has two end sections 25A which can be partially, mostly, or completely retracted within the main section 25B when not in use, and extended when use is desired.

The ladder 1 is conveniently used by placing the third linear section 12 on the windowsill 6. The first linear section 10 is then unlocked, lowered into the desired position as shown in FIG. 1, and then locked. The third linear section 12 and fourth linear section 13, respectively, then are unlocked and the third linear section 12 is pushed through the window opening 3. It may be slid across the windowsill 6 for convenience. The third linear section 12 then is pivoted or rotated into the desired angle with respect to fourth linear section 13, as shown, and then locked into position. Typically, the angle between the third linear section 12 and the fourth linear section 13 will be between 60 and 90 degrees, and more preferably between 70 and 80 degrees, often approximately 73 degrees, but other angles are possible, may be more useful for a different wall thickness, and are contemplated. Third linear section 12 and fourth linear section 13 then are pushed further through the window opening 3 and lowered until the third linear section 12 rests against the exterior 7, as shown. Second linear section 11 then is pushed outward until the first linear section 10 rests against the interior 8. Second linear section 11 and fourth linear section 13 may also be locked into position, if desired. When this has been done the ladder 1 is in the position shown. The first linear section 10 is held against the wall section 5A by the weight of the ladder 1 and/or the weight of any person or object supported by the ladder 1. This first linear section 10, being locked into the position shown, prevents the ladder 1 from being pulled outward through the window opening 3. The third linear section 12 keeps the bottom of the fourth linear section 13 away from the exterior 7, and thereby provides an angle of tilt or lean for the ladder 1 so a worker can stand comfortably thereon.

For example, to lower and lock the first linear section 10 into position, the worker could rest the third linear section 12 of the ladder on the windowsill 6 or ledge 9, and then remove the fasteners from, or otherwise unlock, first joint section 20, which would allow the first linear section 10 to pivot or rotate down to a vertical position. The worker would then re-insert the fasteners into, or otherwise lock, the first joint section 20, thereby locking the first linear section 10 in place with respect to the second linear section 11, and thereby preventing the ladder 1 from being easily pulled out of the window opening 3. The worker could then push third linear section 12 out the window opening 3 and remove the fasteners from, or otherwise unlock, the third joint section 22, thereby allowing the third linear section 12 to pivot with respect to the fourth linear section 13. The worker could then position the third linear section 12 at the desired angle with respect to the fourth linear section 13 and then re-insert the fastener into, or otherwise lock, the locking holes 33. The worker would then remove the fasteners from, or otherwise unlock, second joint section 21 and push the third linear section 12 and the fourth linear section 13 of the ladder 1 further out the window opening 3 and allow the fourth linear section 13 to pivot with respect to the second linear section 11 until the third linear section 12 rested against the exterior 7 of the wall 5A. The worker would then push the ladder 1 further out the window opening 3 until the first linear section 10 rested against the interior 8 of the wall 5A. The worker would then re-insert the fasteners in, or otherwise lock, second joint section 21 and the ladder 1 would then be ready for use.

Other methods of placing the ladder 1 in the window opening 3 also are acceptable. For example, it is possible to put the ladder 1 in the desired final configuration if the window opening 3 is of sufficient size. The preferred dimensions of the ladder 1 are such that this generally is possible. For example, the first linear section 10, the second linear section 11 and the fourth linear section 13 all can be put in the desired positions prior to sliding the ladder 1 out of the window opening 3. The third linear section 12 also could be positioned at the correct angle based on the user's experience prior to sliding the ladder out of the window opening 3. this would reduce the adjustments necessary to the ladder 1 outside of the structure 5.

Once the ladder 1 is properly adjusted and in place in the window opening 3, the worker can then climb onto the top plate 16, and back through the window opening 3 onto the fourth linear section 13 of the ladder 1 in order to clean the window sections 4A, 4B. By standing on the rungs 15 of the fourth linear section 13, the worker can easily reach and clean the exterior of second window section 4B. Then, by raising and lowering first window section 4A and second window section 4B appropriately, the worker can easily expose different sections of window 4 for cleaning.

The ladder of the present invention therefore provides a safe and stable platform for the worker to use for accessing and/or maintaining the exterior of the structure, such as for window cleaning, window replacement, caulking, applying weather stripping, sanding, stripping, painting, etcetera. The ladder is also easy and convenient to transport, deploy, and retract.

The foregoing detailed description of the preferred embodiments and the appended figures have been presented only for illustrative and descriptive purposes. They are not intended to be exhaustive and are not intended to limit the scope and spirit of the invention. The embodiments were selected and described to best explain the principles of the invention and its practical applications. One skilled in the art will recognize that many variations can be made to the invention disclosed in this specification without departing from the scope and spirit of the invention.

### REFERENCE NUMERAL LIST

Number Name

1 Ladder
3 Window opening
4A First window section
4B Second window section
5 Structure
5A Lower wall section
5B Upper wall section
5C Floor
6 Windowsill
7 Exterior of wall 5A
8 Interior of wall 5A
9 Top surface or ledge of wall 5A
10 First linear section of ladder
11 Second linear section of ladder
12 Third linear section of ladder
13 Fourth linear section of ladder
14 Extension section
15 Rungs
16 Top plate
17 Sides or rails on sections
18 Safety harness bar
19 Safety harness hook, latch, or U-bolt
20 First joint section (between 10 and 11)
21 Second joint section (between 11 and 13)
22 Third joint section (between 12 and 13)
23 Fourth joint section (middle of 13)
24 Locking joint
   Number Name
25 Brace
26 First protective covering on 10
27 Second protective covering on 11
28 Third protective covering on 12
30 First joint leg
31 Second joint leg
32 Pivot holes
33 Locking holes
34 Attachment holes
35 Head of joint leg 30, 31

What is claimed is:

1. A ladder comprising:
a first linear section having first and second sides;
a second linear section having first and second sides;
a first locking joint section to connect the first linear section and the second linear section, the first joint section being at least one of lockable or having a limited range of motion;
a third linear section having first and second sides;
a fourth linear section having first and second sides and a plurality of rungs connecting the first and second sides, the fourth linear section being longer than at least one of the first linear section or the second linear section;
a second joint section to connect the second linear section and the fourth linear section toward the top of the fourth linear section; and
a third joint section to connect the third linear section and the fourth linear section toward the bottom of the fourth linear section, the third joint section being at least one of lockable or having a limited range of motion.

2. The ladder of claim 1 wherein the first joint section comprises a first lockable joint to connect the first side of the first linear section to the first side of the second linear section, and a second lockable joint to connect the second side of the first linear section to the second side of the second linear section.

3. The ladder of claim 1 wherein the second joint section comprises a first joint to connect the first side of the second linear section to the first side of the fourth linear section, and a second joint to connect the second side of the second linear section to the second side of the fourth linear section.

4. The ladder of claim 1 wherein the third joint section comprises a first joint to connect the first side of the third linear section to the first side of the fourth linear section, and a second joint to connect the second side of the third linear section to the second side of the fourth linear section.

5. The ladder of claim 1 wherein at least one of the first joint section or the third joint section comprises at least one locking joint.

6. The ladder of claim 1 and further comprising a brace at a first end of the first linear section, and wherein the first joint section is at distal first end of the first linear section from the brace.

7. The ladder of claim 6 wherein the brace extends beyond the first side and the second side of the first linear section.

8. The ladder of claim 6 and further comprising a protective material covering at least a portion of the brace.

9. The ladder of claim 1 wherein the third linear section further comprises a brace at a first end of the third linear section, and wherein the third joint section is at a distal end of the third linear section from the brace

10. The ladder of claim 9 wherein the brace extends beyond the first side and the second side of the third linear section.

11. The ladder of claim 9 and further comprising a protective material covering at least a portion of the brace.

12. The ladder of claim 1 and further comprising a protective material covering at least a portion of the second linear section.

13. The ladder of claim 1 wherein at least one of the first joint section, the second joint section, or the third joint section has a predetermined range of motion.

14. The ladder of claim 1 wherein the second joint section is at one end of the fourth linear section, and further comprising an extension section at this one end, the extension section having a first side connected to the first side of the fourth linear section and a second side connected to the second side of the fourth linear section, whereby the first and second sides of the fourth linear section are effectively extended beyond this one end of the fourth linear section.

15. The ladder of claim 1 wherein the fourth linear section is a foldable assembly comprising:
a first assembly section having first and second sides and at least one rung connecting the first and second sides;
a second assembly section having first and second sides and at least one rung connecting the first and second sides; and
a fourth joint section to connect the first assembly section and the second assembly section, the fourth joint section being lockable.

16. A ladder, comprising:
a first linear section having first and second sides;
a first brace at a first end of the first linear section, the first brace extending beyond the first side and the second side of the first linear section;
a protective material covering at least a portion of the first brace;
a second linear section having first and second sides;
a protective material covering at least a portion of the second linear section;
a first joint section to connect the first linear section and the second linear section, the first joint section being at least one of lockable or having a limited range of motion, the first joint section comprising a first lockable joint to connect the first side of the first linear section to the first side of the second linear section and a second lockable joint to connect the second side of the first linear section to the second side of the second linear section, the first joint section being at a distal end of the first linear section from the first brace;
a third linear section having first and second sides;
a second brace at a first end of the third linear section, the second brace extending beyond the first side and the second side of the third linear section;
a protective material covering at least a portion of the second brace;
a fourth linear section having first and second sides and a plurality of rungs connecting the first and second sides, the fourth linear section being longer than at least one of the first linear section or the second linear section;
a second joint section to connect the second linear section and the fourth linear section, the second joint section comprising a first rotating joint to connect the first side of the second linear section to the first side of the fourth linear section and a second rotating joint to connect the second side of the second linear section to the second side of the fourth linear section; and
a third joint section to connect the third linear section and the fourth linear section, the third joint section comprising a first rotating joint to connect the first side of the third linear section to the first side of the fourth linear section and a second rotating joint to connect the second side of the third linear section to the second side of the fourth linear section, the third joint section being at a distal end of the third linear section from the second brace and being at least one of lockable or having a limited range of motion.
